(19) United States
(12) Patent Application Publication
(10) Pub. No.: US 2026/0011464 A1
(43) Pub. Date: Jan. 8, 2026

(54) ELECTRIC GENERATOR USING GAMMA RADIATION

(71) Applicant: Space Age Technologies, LLC, Poquoson, VA (US)

(72) Inventors: Robert W. Moses, Poquoson, VA (US); Sang H. Choi, Poquoson, VA (US)

(73) Assignee: Space Age Technologies, LLC, Poquoson, VA (US)

(21) Appl. No.: 19/255,356

(22) Filed: Jun. 30, 2025

Related U.S. Application Data
(60) Provisional application No. 63/666,851, filed on Jul. 2, 2024.

(51) Int. Cl. G21H 1/08

(52) U.S. Cl. CPC G21H 1/08

(57) ABSTRACT

An electric generator can include: a radionuclide to emit gamma radiation (GR); an emitter having an emitter atom to receive the emitted GR so that, the GR causes an electron of an emitter atom to be liberated, and thereby be emitted from an emitter surface; a collector spaced from the emitter surface forming a gap between the emitter surface and a collector surface; and a gas having a gas atom and a gas pressure, in the gap, to receive, GR passed through the emitter so that, the received GR causes an electron of the gas atom to be liberated; wherein electrons liberated from the emitter atom and the gas atom are received by the collector, thereby causing an electrical potential difference between the emitter and the collector, and so that an electric current corresponding to a flow of electrons between the emitter and the collector is producible from the collector.

### CROSS REFERENCE TO RELATED APPLICATIONS

The present application claims the benefit of the filing date of U.S. Provisional Application No. 63/666,851, filed Jul. 2, 2024 the contents of which is incorporated herein in its entirety by reference.

### BACKGROUND

Nuclear thermionic avalanche cells (NTAC) generators convert gamma radiation into electrical power. In an NTAC device, gamma radiation impinges on an electron emitter material to release electrons (e.g., also referred to as to liberate electrons) from an electron emitter material. The released electrons, having sufficient energy, then cross a vacuum gap before being collected at an electron collector. The related flow of electrons from the emitter material to the collector material can be used to support an electrical load.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure. The patent or application file contains at least one drawing executed in color. Copies of this patent or patent application publication with color drawing(s) will be provided by the Office upon request and payment of the necessary fee.

FIG. 1—is a schematic illustration of a side view of a partial radial cross-section of an electric generator of the present disclosure;

FIG. 2—is a schematic illustration of the emission spectra of radionuclide cobalt-60;

FIG. 3—is a schematic illustration of the emission spectra of radionuclide sodium-22;

FIG. 4—is a schematic illustration of various arrangements of current conductor attachments to the emitter and the collector of an electric generator of the present disclosure;

FIG. 5—is a schematic illustration of a top view of a diametral cross-section of an electric generator having a cylindrical shape of the present disclosure;

FIG. 6A—is a schematic illustration of atomic interactions with high energy photons with a single gas atom;

FIG. 6B—is a schematic illustration of atomic interactions with high energy photons in a gas with a plurality of gas atoms;

FIG. 7—is a table of gas pressure and corresponding gas density, mean free-path between gas molecules, and experimentally determined emission current;

FIG. 8—is a table of atomic cross-sectional area for various noble gases;

FIG. 9—is a schematic illustration of the energy to release electrons from the various electron shells of various elements;

FIG. 10—is a schematic illustration of Paschen curves for various gases;

FIG. 11—is a block diagram of a control system for the electric generator;

FIG. 12—is a schematic illustration of an encapsulated cell of the present disclosure;

FIG. 13—is a schematic illustration of a test setup of the present disclosure;

FIG. 14—is a graph of output power versus gap distance for a single layer cell of the present disclosure;

FIG. 15—is a graph of output power versus emitter thickness for a single layer cell of the present disclosure; and

FIG. 16—is a graph of open circuit voltage versus gap distance for a single layer cell of the present disclosure.

### DETAILED DESCRIPTION

As disclosed herein, an electric generator can include: a radionuclide configured to emit gamma radiation; an emitter material having emitter material atoms to receive the emitted gamma radiation into the emitter material atoms so that, the gamma radiation causes one or more electrons of the emitter material atoms to be liberated from the emitter material atoms, and thereby be emitted from an emitter surface of the emitter material; a collector material spaced apart from the emitter surface so as to form a gap between the emitter surface and a collector surface of the collector material; and a gas having gas atoms and a gas pressure, in the gap, to receive, into the gas atoms, gamma radiation passed through the emitter material so that, the received gamma radiation causes one or more electrons of the gas atoms to be liberated from the gas atoms; wherein electrons liberated from the emitter material atoms and electrons liberated from the gas atoms are received by the collector material, thereby causing an electrical potential difference between the emitter material and the collector material, and so that an electric current corresponding to a flow of liberated electrons between the emitter material and the collector material is producible from the collector material.

In an implementation, the emitter material and the collector material can each include a cylindrical shape so that the gap has an annular cross-sectional shape.

In an implementation, the emitter material can include a plurality of spaced apart emitter material layers, the collector material can include a plurality of spaced apart collector material layers which can respectively correspond to the plurality of spaced apart emitter material layers so that a plurality of spaced apart gaps are formed between each emitter material of the plurality of spaced apart emitter material layers and each collector material of the plurality of spaced apart collector material layers, and the plurality of spaced apart emitter material layers, the plurality of spaced apart collector material layers, and the plurality of spaced apart gaps can be concentric.

In an implementation, the emitter material and the collector material can each include a metal.

In an implementation, the emitter material and the collector material can each include a transition metal.

In an implementation, the emitter material and the collector material can each include at least one of copper, silver, and gold.

In an implementation, the gas can include an inert gas.

In an implementation, the gas can include a noble gas.

In an implementation, the gas is at least one of argon, krypton, xenon, and radon.

In an implementation, the electrical potential difference can correspond to a number of electrons emitted from the emitter material and a number of electrons received by the collector material.

In an implementation, the electric current can correspond to a number of electrons received by the collector material.

In an implementation, the gap can have a gap distance corresponding to a distance that the collector surface is spaced apart from the emitter surface, and a product of the gas pressure and the gap distance can be between about 0.2 mmHg-cm and about 50 mmHg-cm.

In an implementation, the gas can include argon, and the product is between about 0.5 mmHg-cm and about 3 mmHg-cm.

In an implementation, the gas can include krypton and the product of the gas pressure and the gap distance can be between about 1 mmHg-cm and about 15 mmHg-cm.

In an implementation, the gas can include xenon and the product of the gas pressure and the gap distance can be between about 1 mmHg-cm and about 8 mmHg-cm.

In an implementation, the gap distance can be between about 1 millimeter and about 10 centimeters.

In an implementation, the electric generator can further include an insulator which can be configured to at least partially surround the gap.

In an implementation, the insulator extended between and coupled to edges of the emitter material and the collector material so that the gap is enclosed by the insulator.

In an implementation, the electric generator can further include a containment chamber that can include a transition metal, and the containment chamber can be configured to surround the radionuclide, the emitter material, and the collector material, and to prevent gamma radiation from passing through the containment chamber.

In an implementation, the emitter surface can have a first surface texture which can include a plurality of first peaks having a mean first peak height and a plurality of first valleys having a mean first valley depth, the collector surface can have a second surface texture which can include a plurality of second peaks having a mean second peak height and a plurality of second valleys having a mean second valley depth, and a first difference between the mean first peak height and the mean first valley depth can be less than or equal to a second difference between the mean second peak height and the mean second valley depth.

In an implementation, the first difference can be about two times to about 10 times the second difference.

In an implementation, the gas atoms can receive electrons liberated from the emitter material so that, the received electrons cause one or more electrons contained in the gas atoms to be liberated from the gas atoms.

As disclosed herein, a method can include: disposing a radionuclide in a containment chamber; disposing an emitter material in the containment chamber to at least partially surround the radionuclide; disposing a collector material in the containment chamber to at least partially surround the emitter material and to form a gap between the emitter material and the collector material; filling, at least partially, the gap with a gas; connecting the emitter material to a emitter current conductor; and connecting the collector material to a collector current conductor, to thereby form an electric generator.

In an implementation, the method can further include connecting at least one of the emitter current conductor and the collector current conductor to a controller configured to control a flow of electrons through the at least one of the emitter current conductor and the collector current conductor to produce an electric current.

As disclosed herein, a method of configuring an electric generator including a radionuclide, an emitter material including emitter material atoms, and at least partially surrounding the radionuclide, a collector material at least partially surrounding the emitter material to form a gap between the emitter material and the collector material, and a gas including gas atoms in the gap, the electric generator configured to produce a flow of electrons, the method can include: connecting the emitter material to an emitter current conductor; and connecting the collector material to a collector current conductor, to thereby form the electric generator that produces an electrical current based on transmission of gamma radiation from the radionuclide to the emitter material and gas thereby liberating electrons from the emitter material atoms and the gas atoms.

In an implementation, the method can further include connecting at least one of the emitter current conductor and the collector current conductor to a controller configured to control a flow of electrons through the at least one of the emitter current conductor and the collector current conductor to produce an electric current.

U.S. Pat. No. 10,269,463, the entirety of which is incorporated by reference herein, describes a nuclear thermionic avalanche cell with thermoelectric generator (NTAC-TE) which combines a thermoelectric energy conversion process with the NTAC process to generate electric power. The disclosed NTAC-TE system relies on a vacuum gap between the electron emitter and the electron collector. However, unexpectedly, when such a system was tested with a about 70 mmHg of air in the vacuum gap, it was found that the device could support greater current flow than was predicted based on the amount of gamma radiation emitted.

Based on these findings, it has been determined that when gas atoms are present in the gap, gamma radiation passing through the emitter material retains sufficient energy to interact with the gas atoms to liberate additional electrons from the gas atoms thereby further increasing the electron capacity of the device in comparison to a NTAC device having a vacuum gap.

Accordingly, disclosed herein is an improved NTAC device, and method of operation, having a greater electrical generation capacity in comparison to prior devices or methods.

Prior NTAC devices, having vacuum pressure in a gap between the emitter and the collector, allowed for electrons to run freely across the gap between the emitter and the collector without scattering. In experimental testing, it was observed that the electron emission rate was enhanced when the gap was occupied by any intervening gaseous medium. In seeking an explanation to this later phenomenon, it was determined that when the gap is occupied by gas atoms contribution of liberated electrons from the inner-shells of the gas atoms in the gap exceeded scattering losses of electrons traveling through the gas occupied gap. Therefore, a new electric generator based on NTAC technology which utilizes a gas occupied gap (e.g., such as high atomic number, high-Z, inert gas) is disclosed.

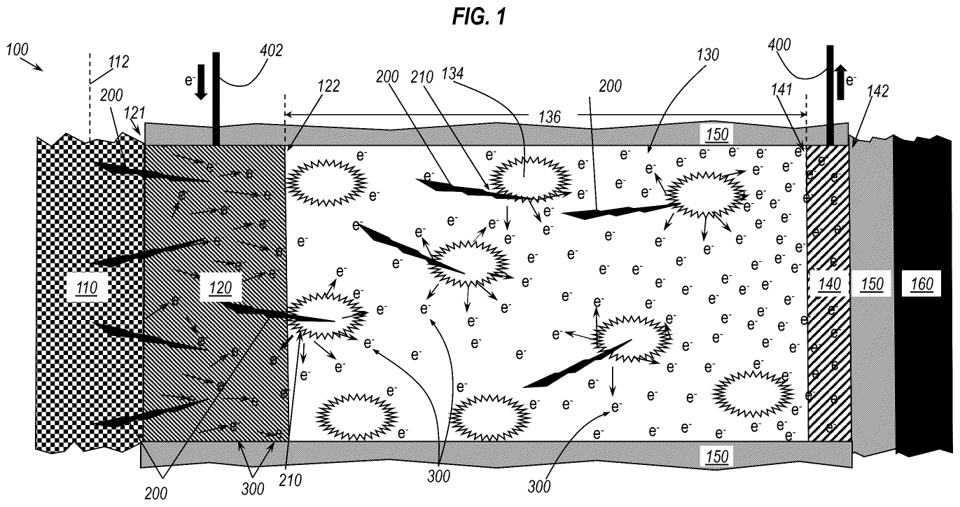

Referring to FIG. 1, an electric generator 100 can include a radionuclide 110, an emitter 120, and a collector 140. The emitter 120 and the collector 140 can be spaced apart from one another to form a gap 130 which can be filled with a gas having gas atoms 134 and a gas pressure.

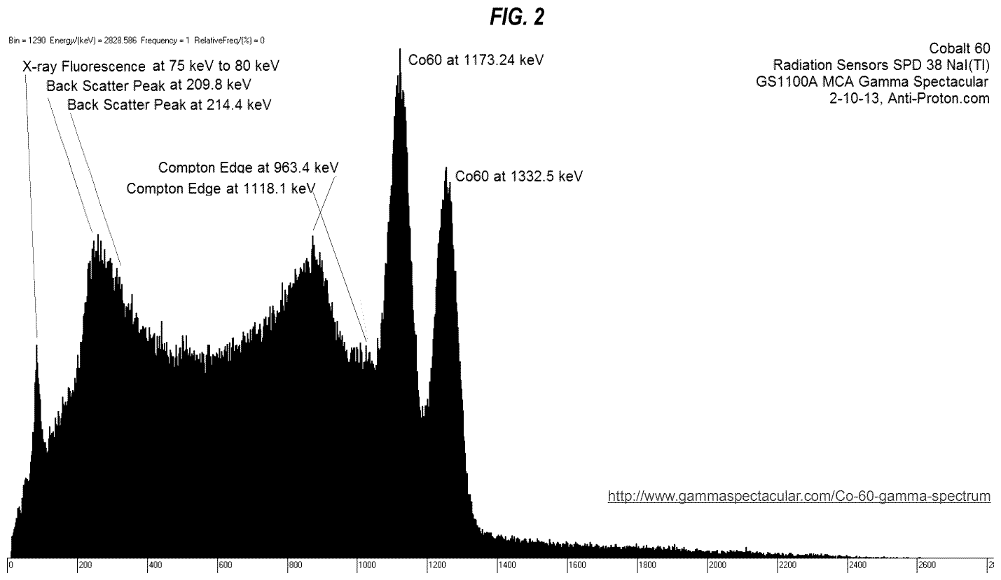

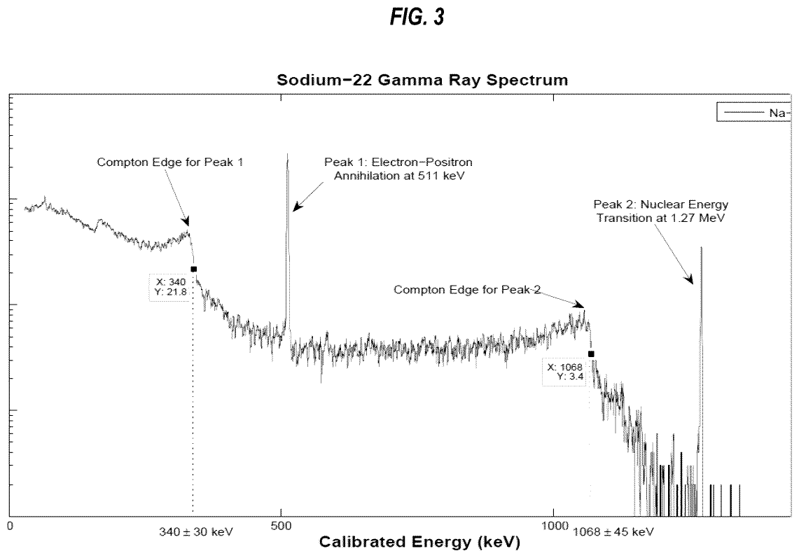

The radionuclide 110 can be any material which emits gamma radiation 200. The radionuclide 110 can be solid, liquid or gas phase. For example, the radionuclide 110 can include a radioactive material such as isotopes of at least one of barium (e.g., Ba-133), cobalt (e.g., Co-60), gallium (e.g., Ga-66), caesium (e.g., Cs-137), iridium, plutonium, radium, radon, sodium (e.g., Na-22, Na-24, Na-32), strontium, thorium, and uranium. In an implementation, the radionuclide can include at least one of cobalt 60 (Co-60), caesium 137 (Cs-137), and sodium 32 (Na-32). The radionuclide 110 can be configured to emit gamma radiation energy of greater than or equal to about 0.5 megaelectron volts (MeV), for example, greater than or equal to about 1.0 MeV. For example, as is shown in FIG. 2, Co-60, which can decay to form Ni-60, can emit two gamma rays having 1.17 and 1.33 MeV, and as is shown in FIG. 3, Na-22, which can decay to form Ne-22, can emit two gamma rays having 511 kiloelectron volts (keV) (0.511 MeV) and one gamma ray having 1.27 MeV.

The emitter 120 can have a first emitter surface 121 facing the radionuclide 110 and a second emitter surface 122 facing the collector 140 (e.g., facing away from the radionuclide 110). The emitter 120 can be a solid phase material and can include emitter material atoms (e.g., atoms of the emitter material). The emitter 120 can include an electrically conductive material such as a transition metal. For example, the emitter 120 can include at least one material from among materials including aluminum, stainless steel, carbon steel, brass, nickel, rhenium, copper, silver, gold, and/or alloys thereof. The emitter can have an emitter thickness (through-plane thickness) of about 0.01 millimeter (mm) to about 5 mm, or about 0.1 mm to about 4 mm, or about 0.1 mm to about 3 mm, or about 0.1 mm to about 2.5 mm, or about 0.01 mm, or about 0.02 mm, or about 0.03 mm, or about 0.04 mm, or about 0.05 mm, or about 0.06 mm, or about 0.07 mm, or about 0.08 mm, or about 0.09 mm, or about 0.1 mm, or about 0.2 mm, or about 0.3 mm, or about 0.4 mm, or about 0.5 mm, or about 0.6 mm, or about 0.7 mm, or about 0.8 mm, or about 0.9 mm, or about 1.0 mm, or about 1.1 mm, or about 1.2 mm, or about 1.3 mm, or about 1.4 mm. or about 1.5 mm, or about 1.6 mm, or about 1.7 mm, or about 1.8 mm, or about 1.9 mm, or about 2.0 mm, or about 2.1 mm, or about 2.2 mm, or about 2.3 mm, or about 2.4 mm, or about 2.5 mm. In an implementation the emitter 120 can include a film of one of the foregoing materials.

The collector 140 can have a first collector surface 141 facing the emitter 120 (e.g., facing the second emitter surface 122) and a second collector surface 142 facing the away from the emitter (e.g., facing away from the radionuclide 110 and facing toward an insulator 150). The collector 140 can be a solid phase material and can include collector material atoms (e.g., atoms of the collector material). The collector 140 can include an electrically conductive material such as a transition metal. For example, the collector 140 can include at least one material from among materials including aluminum, stainless steel, carbon steel, brass, nickel, rhenium, copper, silver, gold, and/or alloys thereof. In an implementation, the emitter material and the collector material can be different materials. For example, the emitter material can include stainless steel, carbon steel, brass, nickel, and/or rhenium and the collector material can include aluminum and/or copper. In an implementation the collector 140 can include a film of one of the foregoing materials.

The second emitter surface 122 and the first collector surface 141 can be spaced apart from each other to form a gap 130 therebetween. The gap can have a gap distance 136 which can correspond to the distance between the second emitter surface 122 and the first collector surface 141. The gap distance 136 can be about 0.001 mm to about 10 mm, or about 0.01 mm to about 10 mm, or about 0.1 mm to about 10 mm, or from about 0.2 mm to about 8 mm, or from about 0.5 mm to about 6 mm, or from about 1 mm to about 5 mm. In an implementation, the gap 130 can be established and/or maintained by a non-conductive material. For example, a non-conductive layer of nylon, fiberglass, silicon, or the like may be in the gap. The non-conductive layer may be a woven layer (e.g., having a loose weave that does not restrict electron flow between the emitter 120 and collector 140).

The gap 130 can be occupied (e.g., at least partially based on the gas pressure) by a gas having gas atoms 134 and having a gas pressure. The gas atoms 134 can be monoatomic or diatomic. The gas can include inert gas (e.g., having its outermost electron shell filled with electrons). The gas can include a noble gas (e.g., a Group 18 element of the periodic table) such as at least one of helium (He), neon (Ne), argon (Ar), krypton (Kr), xenon (Xe), radon (Rn), and oganesson (Og). For example, the gas can include at least one of argon, krypton, and xenon. As described in the foregoing, the liberation of electrons in the gas occupied gap 130 may be enhanced by gases having high atomic number (e.g., high-Z) gases due at least in part to the atomic diameter of the such gases being larger in comparison to lower atomic number gases. For at least this reason, the gas may include at least one of argon, krypton, and xenon. The gas may be a “high purity” gas, such as having a composition of greater than or equal to 99 volume % (vol. %) of the main constituent (e.g., with the remainder being residual gas(es) from the processing of the high purity gas). For example, the gas can include high purity argon having greater than or equal to 99 vol. % argon. In an implementation, the gas may have a main constituent composition of greater than or equal to 99.9 vol. %, or greater than or equal to 99.99 vol. %, or greater than or equal to 99.999 vol. % of the main constituent (e.g., Ar, Kr, Xe, and the like).

In the generation of electrical energy from gamma radiation 200, the radionuclide 110 of the electric generator 100 can emit gamma radiation 200 (e.g., gamma rays) toward the emitter 120. The emitted gamma radiation 200 can be received by an emitter material atom (e.g., received into the electron shell and/or nucleus of the emitter material atom). Interaction between the gamma radiation 200 and the emitter material atom (e.g., such as by coupling 210, Compton scattering, Bremsstrahlung radiation, auger effect, and the like) can cause instability, excitation, and/or release of one or more electrons 300 contained in the emitter material atom (e.g., release of one or more electrons from an electron shell of the emitter material atom). The released one or more electrons 300 from the emitter material atom (e.g., which can also be referred to as liberated electrons) can move through the emitter 120 to be emitted from the surface of the emitter 120. For example, the released one or more electrons 300 can be emitted from the second surface 122 of the emitter 120.

The one or more electrons 300 released from the emitter 120 can also interact with other emitter materiel atoms to liberate additional electrons 300 from other emitter material atoms. Gamma radiation 200 can be re-emitted from emitter material atoms (e.g., after interacting with emitter material atoms) to interact with other material emitter atoms. Gamma radiation 200 which does not interact to emitter material atoms and/or gamma radiation 200 having sufficient energy remaining after interacting with emitter material atoms, can continue to pass through the emitter 120 and can be emitted from the emitter 120 into the gap 130.

Once emitted from the second surface 122 of the emitter 120, the remaining gamma radiation 200 and liberated electrons 300 can continue to move through the gap 130 where they can interact with gas atoms 134 occupying the gap 130. Interactions between the gamma radiation 200, electrons 300 liberated from the emitter material atoms, and/or electrons 300 liberated from the gas atoms 135 (e.g., such as by coupling, Compton scattering, Bremsstrahlung radiation, auger effect, and the like) can produce additional liberated electrons 300. The liberated electrons 300 can move through the gap 130 toward the collector 140. The movement of electrons through the gap 130 can be based on random motion of the particles as they are liberated and/or based on an induced electrical potential between the emitter 120 and the collector 140 (e.g., which can act to drive electrons to the collector).

This process of releasing energetic electrons by gamma interactions and electron interactions can cause an avalanche, or snowballing, effect where, as the number of free electrons 300 grows with the number of atomic interactions (e.g., electron-electron interactions, gamma-electron interactions, gamma-atomic nucleus interactions). Because the gap 130 can include high-Z gas atoms 134 (e.g., argon), having relatively large electron shells (e.g., in comparison to an unoccupied vacuum-gap, or a gap occupied by smaller atoms such as air having about 79 vol. % nitrogen and about 21 vol. % oxygen), the population of liberated electrons 300 from the gas atoms 134 occupying the gap 130 can increase and the number of electrons 300 collected at the collector 140 can correspondingly increase. Thus, by this avalanche effect the electron density, or current density, of the electric generator 100 is improved relative to NTAC devices which have a vacuum gap or which have an air occupied gap.

Although only one emitter/collector pair is shown in FIG. 1, the electric generator 100 can include a plurality of emitter/collector pairs arranged adjacent to one another (e.g., such as stacked in a planar arrangement, or concentric in a cylindrical, hemispherical, partially spherical, or like arrangement). For example, the electric generator 100 can include two or more emitter/collector pairs, three or more emitter collector pairs, four or more emitter/collector pairs, five or more emitter/collector pairs, six or more emitter/collector pairs, seven or more emitter/collector pairs, eight or more emitter/collector pairs, nine or more emitter/collector pairs, or ten or more emitter/collector pairs. As the number of emitter/collector pairs increases the amount of gamma radiation 200 transmitted through the emitter/collector pair furthest from the radionuclide 110 can decrease (e.g., as the energy of the gamma radiation 200 is reduced by atomic interactions in emitter/collector pairs closer to the radionuclide 110). In an implementation, the electric generator can have from four to eight emitter/collector pairs.

The one or more emitter/collector pairs can be bounded on one side by the radionuclide 110 and on the other side by an insulator 150. The electrical generator 100 can be surrounded by a containment chamber 160. In a planar arrangement, the radionuclide 110 can be at one end of the planar stack, or can be at a middle of the planar stack so as to have a center of symmetry 112 so that the stack arrangement is mirrored on either side of the center of symmetry 112. In a cylindrical arrangement, the center of symmetry 112 can form an axis about which the emitter/collector pairs are concentric.

The containment chamber 160 can include a non-conductive material such as concrete (e.g., steel reinforced concrete) or, with a non-conductive insulator 150 between the last collector 140 of the stack, the containment chamber 160 can include a conductive material such as lead, tungsten, and the like. The containment chamber 160 can include high density materials (e.g., having a density of greater than or equal to about 10 gram/cubic centimeter (g/cm³)) to help reduce emission of gamma radiation 200 from the electric generator 100.

The radionuclide 110 can be at a center of the planar or cylindrical stack so as the form a core of the electric generator 100. The first emitter 120 can be positioned adjacent to the radionuclide 110, so as to cover or surround the radionuclide 110. The first collector 140 can be spaced apart from the first emitter 120 to form the first gap 130. Between subsequent emitter/collector pairs (e.g., after the first pair which is adjacent to the radionuclide 110) each emitter/collector pair can be separated by an insulator 150.

The insulator 150 can include a non-conductive material, such as a polymer (e.g., acrylic, polypropylene, polyester, stretched polyester, polyimide polyethylene, silicone, polyvinyl chloride, and the like). In an implementation the insulator 150 can include a film of one of the foregoing materials. The insulator 150 can be positioned between adjacent emitter/collector pairs to prevent electrical communication between the collector 140 and an emitter 120 from adjacent emitter/collector pair (e.g., a short circuit and/or current leakage). The insulator 150 can be disposed to at least partially surround the gap 130. The insulator 150 can be configured to enclose the gap 130. For example, in a planar arrangement, the insulator 150 can be extend between the second emitter surface 122 and the first collector surface 141 along on all four corresponding edges of the planar surfaces of the emitter 120 and the collector 140 so that the gap 130 is enclosed along all four edges of the planar arrangement. Further, in a cylindrical arrangement, the insulator 150 can be extended between the second emitter surface 122 and the first collector surface 141 at a top and at a bottom of the emitter 120 and the collector 140 (e.g., the collector 140 can be formed in concentric rings which each cover at least one of the emitter 120, the gap 130, and/or collector 140, or can be formed as a single ring covering all emitter/collector pairs in a cylindrical arrangement) so that the gap 130 is enclosed along both edges (e.g., top and bottom edges) of the cylindrical arrangement.

The insulator 150 can be coupled to edges of the emitter 120 and/or the collector 140 (e.g., top and bottom edges, and/or side edges in a planar arrangement). The insulator 150 can be sealed against edges of the emitter 120 and/or the collector 140 (e.g., top and bottom edges, and/or side edges in a planar arrangement). For example, and adhesive can be disposed between the insulator 150 and a surface of the emitter 120 and/or a surface of the collector 140 so that the insulator 150 is held in contact with the surface. In this way, liberated electrons 300 can be contained within the gap 130 and guided from the emitter 120 to the collector 140 without having another conduction pathway. The insulator 150 can be disposed to surround the emitter 120 and the collector 140. For example, in a planar arrangement, the insulator 150 can be disposed to surround all four edges of the emitter 120 and the collector 140. In this way, liberated electrons 300 can be guided from the emitter 120 to the collector 140 and then to the collector current conductor 400 for transport to an electrical load.

The electric generator 100 can further include a collector current conductor 400 and an emitter current conductor 402 to pass electrical current generated by the electric generator 100 to an electrical device. For example, the collector current conductor 400 can be in electrical communication (e.g., coupled by wires, soldering, and the like) with a positive terminal of the electrical device, and the emitter current conductor 402 can be in electrical communication with a negative terminal an electrical device. In this way, electrical current generated by the electric generator 100 can flow from the collector 140, through the collector current conductor 400, through the electrical device (e.g., electrical load, power conditioner, or the like), through the emitter current conductor 402, and back to the emitter 120. The collector current conductor 400 and/or the emitter current conductor 402 can pass through the insulator 150 so that electrons are guided through an electrical circuit formed between the electric generator 100 and a load to which the electric generator 100 is attached.

The collector current conductor 400 can include any suitable electrical conductor such as a metal (e.g., copper, gold, and the like). The collector current conductor 400 can be coupled to the collector 140 at one or more points. For example, the collector current conductor 400 can be attached to the collector 140 at one or more points at, or near, a center location, an edge location, and/or a corner location (e.g., in a planar arrangement). Furthermore, in a cylindrical arrangement with the collector 140 having a cylindrical shape, the collector current conductor 400 can be attached to the collector 140 at one or more points along a circumference, a perimeter, and/or one or both ends of the collector 140.

The emitter current conductor 402 can include any suitable electrical conducting material such as a metal (e.g., copper, gold, and the like). The emitter current conductor 402 can include the same electrically conducting material as the collector current conductor 400. The emitter current conductor 402 can be coupled to the emitter 120 at one or more points. For example, the emitter current conductor 402 can be attached to the emitter 120 at a center location, at an edge location, and/or a corner location (e.g., in a planar arrangement). Furthermore, in a cylindrical arrangement with the emitter 120 having a cylindrical shape, the emitter current conductor 402 can be attached to the emitter 120 at one or more points along a circumference (e.g., an inner circumference or outer circumference of the cylindrical shape), and/or one or both ends of the emitter 120.

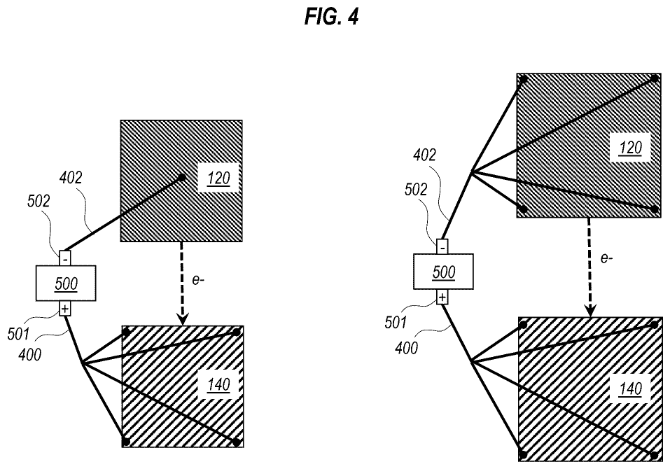

FIG. 4 shows electrical connections for an emitter 120 layer and a collector 140 layer of an electric generator 100 having a planar arrangement. In a planar arrangement, the collector current conductor 400 can be attached to the collector 140 (e.g., each collector 140 at each collector 140 layer in a stack) at, or near, a center, one or more edges, or one or more corners of the collector 140, and the emitter current conductor 402 can be attached to the emitter 120 (e.g., each emitter 120 at each emitter 120 layer in the stack) at, or near, a center, one or more edges, or one or more corners of the emitter 120. The emitter current conductor 402 and the collector current conductor 400 can be attached to an electrical device 500 to provide electrical power to the electrical device 500. For example, the collector current conductor 400 can be disposed in electrical communication with a positive terminal 501 of the electric device 500 and the emitter current conductor 402 can be disposed in electrical communication with a negative terminal 502 of the electrical device 500.

In experimental testing, it was found that in a planar arrangement, charge density can be higher at the emitter 120 edges and/or corners in comparison to charge density at the center of the emitter 120. Accordingly, in an implementation, in a planar arrangement, the collector current conductor 400 can be attached to the collector 140 at, or near, one or more corners of the collector 140 and the emitter current conductor 402 can be attached to the emitter 120 at the center of the emitter 120. In this way, disparity in electrical potential distribution (e.g., voltage difference between the emitter 120 and the collector 140 as a function of position on the emitter 120 and collector 140) across the emitter 120 and the collector 140 can be reduced.

As a result of the geometry of the electric generator 100 (e.g., planar, cylindrical, hemispherical, partially spherical, and the like) and distance from the radionuclide 110, the electrical potential between emitter/collector pairs (e.g., adjacent emitter/collector pairs), and the current flow between emitter/collector pairs can be different throughout the electric generator 100. Therefore, it can be advantageous to condition the electrical power from one or more emitters 120, collectors 140, and/or emitter/collector pairs of the electric generator 100 with a power conditioning device (e.g., voltage regulator, DC/DC converter, DC/AC inverter, and the like). For example, a power conditioner can be interposed between one or more emitters of a plurality of emitters 120, one or more collectors of a plurality of collectors 140, and/or one or more emitter/collector pairs of a plurality of emitter/collector pairs and an electrical device which is to be powered by the electric generator 100. A power conditioner can allow for collector current conductors 400 corresponding to a plurality of collectors 140, and/or emitter current conductors 402 corresponding to a plurality of emitters 120 to be united into a single line for transferring electrical energy to/from an electrical device to be powered by the electrical generator 100.

For example, one or more collectors 140 can be connected to a buck/boast DC/DC converter so as to buck voltage of higher voltage collectors 140 and boast voltage of lower voltage collectors 140 and to thereby align the voltages of the collectors 140 so that they can be unified into a single electrical lead (e.g., a positive lead or a negative lead of the electrical generator 100). Similarly, one or more emitters 120 can be connected to a buck/boast DC/DC converter so as to buck voltage of higher voltage emitters 120 and boast voltage of lower voltage emitter 120 and to thereby align the voltages of the emitters 120 so that they can be unified into a single electrical lead (e.g., a negative lead of the electrical generator 100).

The electrical generator 100 can include a switch to control the flow of electrical current from the electrical generator 100. For example, the switch can be interposed between the one or more collectors 140 and/or the one or more emitters 120, and an electrical device to be powered by the electric generator 100. The switch can open and close a circuit formed between the electrical generator 100 and the electrical device to be powered by the electric generator 100.

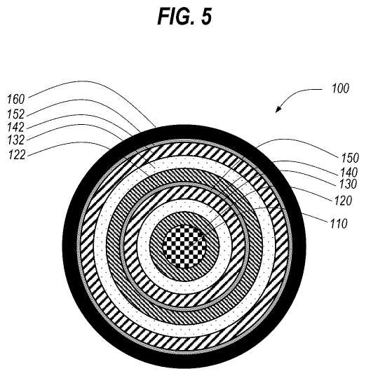

Referring to FIG. 5, the electric generator 100 can have a cylindrical shape so as to have a circular diametral cross-section. As previously described, the radionuclide can be at the center of the cross-section with one or more emitter/collector pairs stacked concentrically therearound. The emitter 120 and collector can be spaced apart to form an annular gap 130 therebetween. The annular gap 130 can be occupied with a gas having gas atoms 134 and a gas pressure. An insulator 150 can be between the first emitter/collector pair and the second emitter/collector pair and another insulator 150 can be between the second emitter collector pair and the containment chamber 160. In FIG. 5 only two emitter/collector pairs are shown, but as previously discussed, the stack can be extended to have a greater number of emitter/collector pairs.

The electric generator can have a high rate of liberated electrons in comparison to a device having a vacuum gap or air occupied gap due to a combination of an increased collision rate with gas atoms 134, and a low probability of recombination with the gas atoms 134. To achieve such an improvement, the gas pressure, gas species and gap distance 136 can be selected to optimize the electron generation potential. As previously discussed, high-Z inert gases, such as argon, krypton, and xenon, can have plenty of releasable electrons from their inner-shells of atomic structure which can make these gases suitable for occupying the gap 130. Further, these gases do not include hydrogen which can evolve from the gas phase and passivate components of the electric generator 100.

Regarding the collision rate in the gap 130, high-Z inert gases have a large atomic cross-section (in comparison to low-Z gases, e.g., gases with an atomic number less than 18) which can provide a large collisional cross-section for photons and energized electrons. As such, the probability of collision with high energy photons can be higher for high-Z gases than with low-Z gases. As discussed above, FIG. 1 describes the population increase of the liberated electrons from inert gas atoms through a coupling process with the incident high energy photons within the space of the gap 130 between the emitter 120 and the collector 140. In this case, when a high energy photon interacts with a high-Z gas atom, electrons located in the inner electron shell(s) of atomic structure can be liberated (e.g., by interactions including photoelectric effect, Compton scattering, photonuclear effect, electron-positron pair production, and the like).

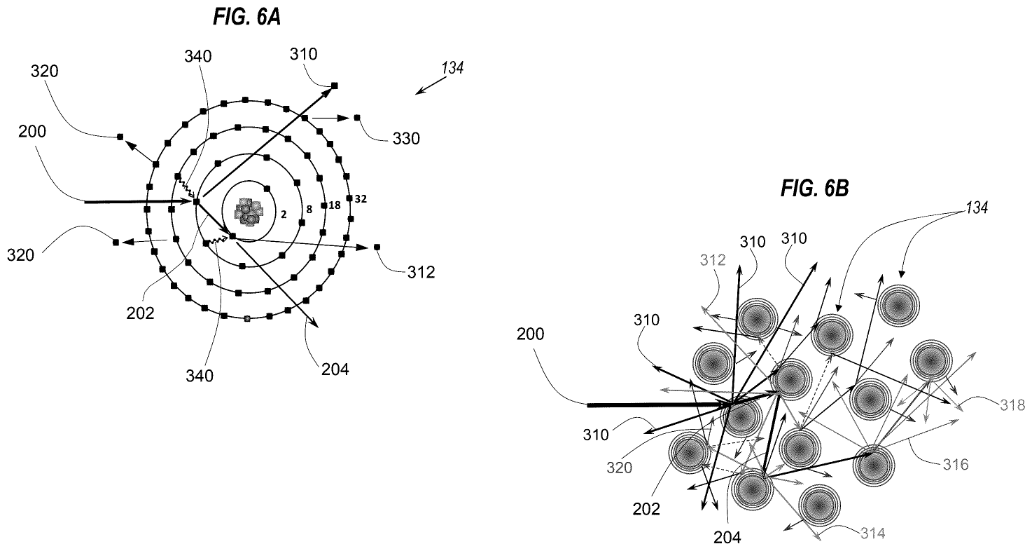

Referring to FIG. 6A, the liberated electrons can include the primary Compton electrons 310 which carry high kinetic energy, Auger electrons 320 (e.g., resulting from the filling of an inner shell electron causing a corresponding release of an outer shell electron), and field coupled electrons 330. Furthermore, after a primary gamma radiation-electron collision causing the release of a primary Compton electron 310, Compton scattered gamma radiation 202 can continue through the electron shell. In the electron shell, the primary Compton scattered gamma radiation 202 can have secondary interactions which can liberate secondary Compton electrons 312 and secondary Compton scattered gamma radiation 204. Additionally, production of Bremsstrahlung radiation 340 can occur during the Compton interaction. This cascading of electron and gamma emissions can continue in the electron shell and extend outside the electron shell of a first gas atom 134 to other gas atoms 134.

Referring to FIG. 6B, since the Compton electrons 310 carry high kinetic energy, the primary Compton electron 310 can have a high probability of collision with other electrons in the gas atom electron shell to liberate secondary electrons 312 and/or collision with other neighboring high-Z gas atoms 134 which can liberate additional electrons from other high-Z gas atoms 134. Accordingly, gamma radiation 200 can cause a rippling effect, where gamma radiation 200 produces primary Compton electrons 310, secondary Compton electrons 312, tertiary Compton electrons 314, quaternary Compton electrons 316, quinary Compton electrons 318, and so forth. Through such interactions, in addition to those electrons 300 emitted from the surface of the emitter 120, the population of liberated electrons can be increased within the gas occupied gap 130.

Interactions with high energy photons (e.g., having energy levels in the hundreds of kiloelectron volts (keV) to megaelectron volts (MeV)) can penetrate deep into inner electron shells and/or couple with the nucleus of gas atoms 134. When a high energy photon couples with a nucleus of a gas atom 134, additional electrons from the inner-shells of the gas atoms 134 can be liberated in combination with the aforementioned Compton electrons 310, the Auger electrons 320, and the field-coupled electrons 330. Compton electrons 310 can possess high kinetic energy and when transferred to another electron through the Compton scattering process the impact of this energetic electron onto neighboring gas atoms 134 can deliver substantial energy which can lead to liberation of inner-shell electrons from those neighboring gas atoms 134.

After the Compton scattering, a high energy photon (e.g., gamma radiation 200, 202, 204, and the like) can still carry substantial levels of energy; enough energy that sequential interactions with neighboring gas atoms 134 (e.g., such as high-Z gas atoms) can continue.

Even when a high energy photon reaches to and directly couples with a nucleus, the photon energy transferred to the nucleus (e.g., which is not greater than about 1.022 MeV) can cause the nucleus to undergo an unstable resonant mode of oscillation. The electrons around the nucleus under the unstable resonant mode can experience weakening of electron quantum binding that might lead to quantum level transitions, such as electronic, vibrational, and rotational energy transitions. If the photon energy is greater than about 1.022 MeV, the pair production of electron and positron (e.g., which can carry about 511 keV energy, respectively), can occur.

If the photon energy is higher than the binding energy of nucleons, there may be possible emission of either a proton or a neutron from nucleus. For example, with argon gas which has a binding energy per nucleon of about 8.595 MeV, any photon energy greater than about 8.595 MeV can liberate a nucleon from argon nucleus. For krypton and xenon, the binding energy per nucleon is about 8.513 MeV and about 8.413 MeV, respectively.

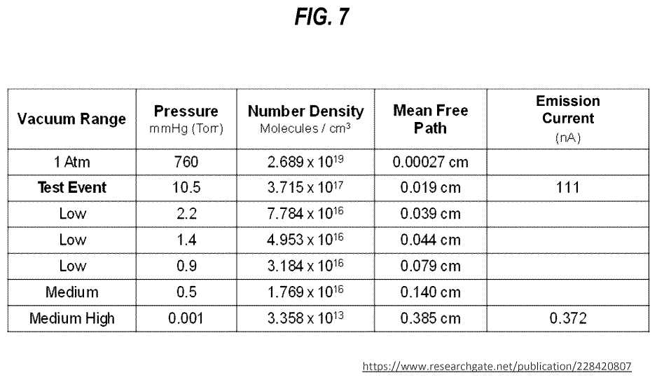

The recombination probability of these electrons back into ionized gas can be much lower than for a solid phase material because the mean free-path of electrons in a gas phase is increased relative to a solid phase material. The mean free-path in the gas can be further increased based on the gas pressure. For example, FIG. 7 shows that the mean free-path of electrons in argon gas can be increased from about 2.7×10⁻⁴ centimeters (cm) to about 3.85 10⁻¹ cm as the gas pressure is decreased from about 760 millimeters of mercury (mmHg) to about 0.001 mmHg. According to FIG. 7, at 1 millitorr (mTorr) vacuum pressure (e.g., where the aforementioned experimental testing was performed), the mean free-path of electrons can be about 3.85 mm. Since, in some of the experiments, the gap 130 between the emitter 120 and the collector 140 was about 3 mm, most electrons travel across the gap 130 without interacting with the gas atoms 134. FIG. 1 shows the motion of electrons crossing the gas occupied gap 130 towards the collector 140 without recombination. This aspect is somewhat similar to a long distance that the electrons can travel without collision as described in FIG. 7 for the mean free-path of electrons in argon gas.

The mean free-path distance of the gas atoms 134 (e.g., the mean distance between atoms) can, at least partially, determine the probability of electron liberating interactions within the gap 130. Therefore, the gap distance 136 and the gas pressure can be selected to optimize liberation of electrons (e.g., with respect to other constraints) and thereby maximize current density of the electric generator 100. For example, the density of the gas atoms 134 in the gap 130 (e.g., corresponding to the gas pressure) can be selected, thereby setting the travel distance of electrons traveling through the gap 130, so that interactions (e.g., between liberated electrons and gas atoms 134) is more (or less) likely to occur before the electrons cross the gap 130 and reach the collector 140.
, or reducing the gap distance 136,

The gas density in the gap 130 can be a function of the gap distance 136 and the gas pressure. For example, at a fixed gap distance 136, increasing the gas pressure in the gap 130 can increase the gas density in the gap 130 and reduce the mean free-path distance between gas atoms 134 thereby making interactions in the gap 130 more likely to occur. Meanwhile, at a fixed gas pressure, increasing the gap distance 136 can decrease the gas density in the gap 130 and increase the mean free-path making interactions less likely to occur. Accordingly, the gas pressure in the gap 130 and the gap distance 136 can be selected to optimize liberation of electrons. However, at the same time, adjusting the mean free-path can influence the probability of gamma interactions (e.g., between gamma radiation and gas atoms 134) in the gap 130.

With reference to FIG. 7, at a pressure level at 1 mTorr, on average, electrons can travel through about 3.85 mm of gas atoms 134 without recombination with, or scattering by, a gas atom. This mean free-path can indicate low probability of recombination such that many of electrons can travel through and arrive at the first surface 141 of collector. 140 without interacting with a gas atom 134

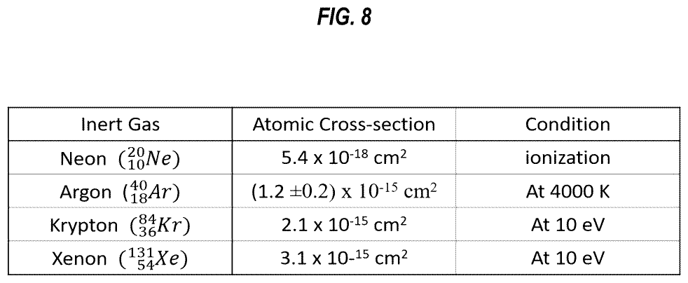

Referring to FIG. 8, the optimal pressure setting for mean mean-path can depend on the cross-sectional diameter of the gas atom as shown in Table 2. However, because the differences in atomic cross-sectional diameter among high-Z gases (e.g., Ar, Kr, and Xe) are not so large, the gap distance and the gas pressure can be regarded as the two major parameters to determine the optimized performance of electric generator. For argon, a pressure of 1 mTorr can provide a low probability that liberated electrons will collide with gas atoms 134 as they travel from the second emitter surface 122 to the first collector surface 141 when the gap distance is about 3 mm. However, at a gas pressure of 1 mTorr, the rate of photon coupling may not be optimally sustained. A higher rate of gas-photon coupling can occur at the pressure from 1 to 10 Torr. Therefore, a balance between gap distance and gas pressure in the gap 130 can be sought such that the occurrence of gamma and electron interactions in the gap is optimized. For example, the gas pressure in the gap 130 can be set so that the mean free-path distance of electrons in the gap 130 is about equal to the gap distance 136. When the gap distance 136 is about equal to the mean free-path distance of electrons in the gap a reasonable coupling rate of high energy photons with the gas atoms 134 can be maintained.

By this relationship between the gap distance 136 and the gas pressure, a tradeoff can be made to optimize performance (e.g., current density) of the electric generator. For example, the gas pressure in the gap 130 can be set such that the mean free-path for electrons in the gas is about 0.5 to about 3.0 times the gap distance. For example, the gas pressure can be about 1 mTorr and the gap distance 136 can be less than about 5 mm, or from about 3 millimeters (mm) to about 5 mm, or from about 3.5 mm to about 4.2 mm, or about 3.85 mm, or the gas pressure can be about 0.5 Torr and the gap distance 136 can less than about 3 mm, or from about 0.5 mm to about 3 mm, or from about 0.7 mm to about 2.1 mm, or about 1.4 mm, or the gas pressure can be about 0.9 Torr and the gap distance 136 can less than about 2 mm, or from about 0.1 mm to about 2 mm, or from about 0.5 mm to about 1.5 mm, or about 0.79 mm, and the like.

Furthermore, controlling the gap distance 136 in a manufactured device (e.g., such as for small gap distances of less than about 5 mm) can be difficult to consistently achieve, can be time consuming to consistently achieve, and/or can increase manufacturing costs (e.g., tooling costs, labor costs, quality control costs, and the like). Therefore, other factors which can be considered in setting the gap distance 136 and/or the gas pressure can include producibility, production time, and/or production cost.

In experimental testing using a planar NTAC having an argon gas pressure of about 10.5 Torr in the gap 130 and a gap distance or about 3 mm, emission current of electrons was about 111 nanoamps (nA) while at gas pressure of about 1 mTorr the emission current of electrons dropped to about 0.372 nA as shown in FIG. 4. Not to be bound by theory, it is theorized that electrons emitted from the surface of emitter can be scattered by the intervening high-Z gas atoms. The Auger electrons 320 and the field-coupled electrons 330 emitted from the second emitter surface 122 can carry relatively low energy. These low energy electrons might have a larger cross-sectional area in comparison to higher energy (e.g., Compton electrons), so that they can more easily recombined with ionized high-Z gas atoms. Or, the collisions between these low energy electrons and high-Z gas atoms can transfer the Penning charges to plain high-Z gas atoms. These effects can reduce the electron stream density thereby reducing current density of the NTAC device. On the other hand, the Compton electrons emitted from the second emitter surface 122 can carry greater energy in comparison to the Auger and field-coupled electrons, (e.g., up to a few hundred of keV). These Compton electrons can undergo multiple collisions with high-Z gas atoms in the gap 130. In such processes, high-Z gas atoms, after collisions with energetic Compton electrons, can liberate many electrons from the inner shell of high-Z gas elements as discussed in the foregoing. The emitted electrons which carry high energy can undergo additional collision processes to liberate more electrons. Subsequently, the number of liberated electrons within the gap space can be increased in comparison to NTAC devices having a vacuum gap or air occupied gap, which can increase the current density of the NTAC device having high-Z gas atoms occupying the gap.

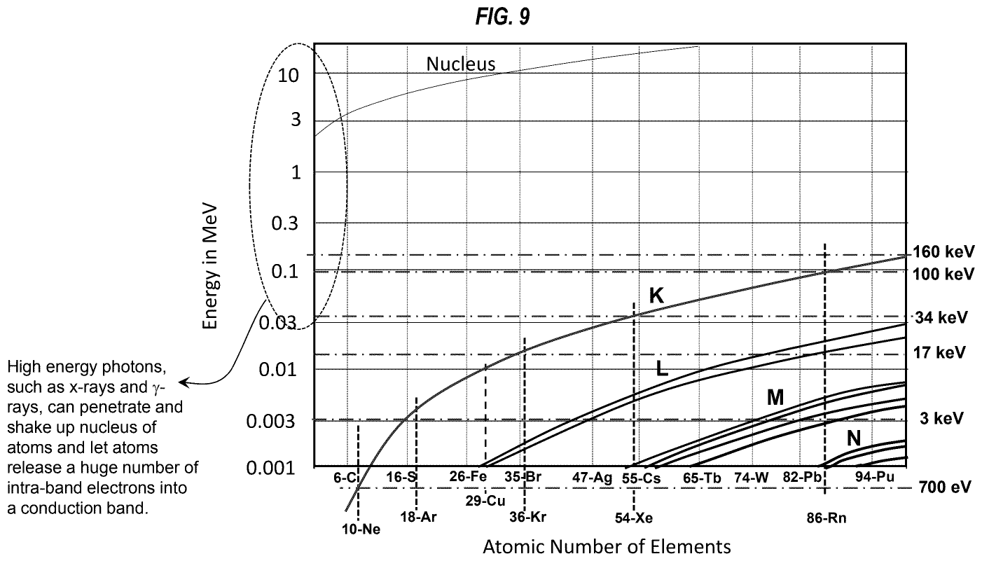

FIG. 9 shows the energy to release inner-shell electrons (e.g., from the K, L, M, or N electron shells) and nucleons from an atom. The K-shell is the inner-most electron shell of the atomic structure. An energy level that can liberate the K-shell electrons is sufficient to liberate the rest of the electrons of the remaining outer electron shells. For example, the removal of the argon's K-shell electrons may be about 3 keV. For krypton, about 17 keV is needed for the liberation of K-shell electrons. For the xenon case, about 34 keV may be needed for the liberation of the K-shell electrons. Even though it appears that the liberation of the K-shell electrons from krypton (e.g., about 17 keV) and xenon (e.g., about 34 keV) may use much higher energy than the energy (e.g., about 3 keV) for argon, actually, the overall number of removable electrons from the krypton and xenon atoms is 2 or 3 times more than the 18 electrons of argon. This can indicate that the higher energy interactions can release more electrons.

The overall number of liberated electrons can be dependent on the coupling rate of gas atoms 134 (e.g., high-Z gas atoms) with gamma radiation 200 and/or with high energy photons (e.g., x-ray or other releases from gamma radiation 200 interactions with atoms). The coupling rate can be increased by the density of high-Z inert gas and the flux density of gamma radiation 200 and/or high energy photons. The experimental testing showed that the reading of current was increased when the gap 130 between the emitter 120 and the collector 140 was filled with high-Z inert gas. Not to be bound by theory, it is believed that the increase in electron population at the tested pressure range (10.5 Torr) of the argon filled gap 130 may not signify the optimum gas pressure for maximizing the number of liberated electrons from argon gas but shows an incremental tendency of additional electron populations by virtue of at least the photon coupling of argon gas. Although the increased gas pressure caused an increase in the photon coupling rate, it can also raise the scattering rate of liberated electrons 300 as they cross the gap 130.

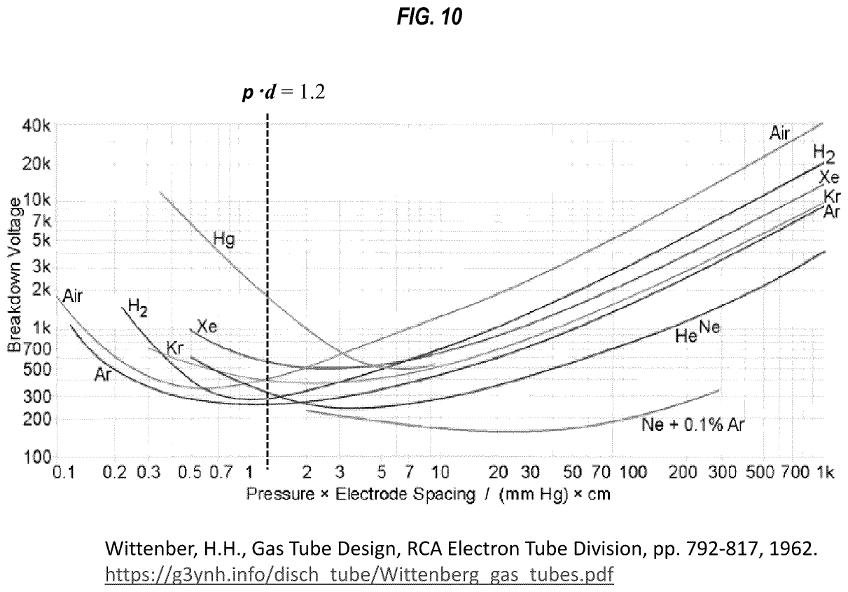

Again, not to be limited by theory, it is believed that a Paschen curve (see FIG. 9) can help to establish an optimal gas pressure and gap distance 136 for a selected type of gas atom. Referring to FIG. 10, the breakdown voltage curves (e.g., Paschen curves) for different types of gas atom 134 is shown as a function of the gas pressure (p) and the electrode spacing (d) (e.g., corresponding to the gap distance 136). The p·d range corresponding to the minimum of the Paschen curve can be the optimized product of pressure (p) and the gap distance (d) for the highest Coulomb transfer. The lowest breakdown voltage for argon may be p·d=1.2 Torr·cm. Based on this diagram, it can be interpreted that, after the ionization of argon at the lowest breakdown voltage, the electrical current develops its stream for high Coulomb transfer across the gap 130 between electrodes (e.g., between emitter 120 and collector 140). This breakdown phenomenon can also indicate the ionization of gas atoms 134 that can reduce electrical resistance through the gas atoms 134 which allows highest possible Coulomb transfer.

Under the aforementioned experimental conditions, with a photon source of about 2.5057 MeV, a current flow of about 111 nA was achieved at a gas pressure of 10.5 Torr whereas a current flow of about 0.372 nA was achieved at a gas pressure of 1.0 mTorr through a gap 130 having a gap distance of about 0.3 cm. Therefore, at the higher current density the p·d=about 3.15 Torr·cm. According to FIG. 10, at p·d=3.15 Torr·cm the breakdown voltage is about is 300 V at a p·d of 3.15 Torr·cm and about 270 V at a p·d of about 1.2 Torr·cm. This corresponds to about a 30 V difference in breakdown voltage between the minimum of the Paschen curve and the point at which the experiment was conducted. Therefore, if a p·d of about 1.2 Torr·cm represents the optimized condition, the most reasonable pressure of argon for high Coulomb transfer or electron transmission in the gap 130 of 3 mm would be about 4 Torr instead of 10.5 Torr. However, the Paschen curve give more insight by providing a range of p·d values an array of gas pressure and gap distances 136 can be selected to keep the breakdown voltage at a minimum value and thereby provide the highest electron density to the NTAC device. For example, for high-Z inert gases, a product of the gas pressure and the gap distance 136 can be between about 0.2 mmHg-cm and about 50 mmHg-cm, or between about 0.5 mmHg-cm and about 3 mmHg-cm, or between about 1 mmHg-cm and about 15 mmHg-cm, or between about 1 mmHg-cm and about 8 mmHg-cm, or can optimize electron density. When the gas atoms 134 include argon, optimized current density can be at where the product of the gas pressure and the gap distance 136 is between about 0.5 mmHg-cm and about 3 mmHg-cm. When the gas atoms 134 include krypton, optimized current density can be at where the product of the gas pressure and the gap distance 136 is between about 1 mmHg-cm and about 15 mmHg-cm. When the gas atoms 134 include xenon, optimized current density can be at where the product of the gas pressure and the gap distance 136 is between about 1 mmHg-cm and about 8 mmHg-cm.

With any of these optimal p·d values the gap distance 136 can be chosen to meet other criteria, such as producibility (e.g., manufacturability), production time, and/or production cost. For example, a gap distance 136 of between about 1 mm and about 10 cm, or between about 1 mm and about 50 mm, or between about 1 mm and about 20 mm, or between about 1 mm and about 10 mm, or between about 1 mm and about 5 mm, or about 1 mm, or about 2 mm, or about 3 mm, or about 4 mm or about 5 mm, may be selected so as to keep the cost of manufacturing reasonable in comparison to smaller gap distances 136 which may rely on special tooling and/or quality controls to ensure the gap distance 136 is maintained between the entire emitter second surface 122 and the collector first surface 141.

A further consideration in selecting the gap distance 136 can include the possibility of electron recapture. For example, when the gas in the gap 130 losses electrons and becomes ionized, the ionized gas can recapture electrons which can revert the gas to the non-ionized, e.g., base state. Longer or repeated high flux photon coupling interactions of the gas atoms 134 within the gap 130 can increase the saturation level of ionized gases. If this occurs, an increased ion population in the gap 130 can lead to a quantum state for quenching or inversion to a ground state by capturing electrons which can result in emission of low energy photons, but can reduce the current density of the electric generator 100.

### Listing of Features:

At least because of their large cross-sectional areas, high-Z inert gas atoms 134, such as argon, krypton, and xenon, can exhibit better photon-coupling in comparison to atoms of low-Z gases, which can result in deep-level ionization (e.g., liberation of inner-shell electrons) when coupled with high energy photons.

The number of liberated electrons from gas atoms 134 (e.g., such as atoms of high-Z inert gases) can add significantly to the electrons liberated from the emitter material so as to increase current density of the electric generator 100.

Electrons liberated from gas atoms 134 (e.g., such as high-Z inert) can increase the electron density and provide for high Coulomb transfer across the gap distance 136 between the emitter 120 and the collector 140.

The interaction between the gas atoms 134 (e.g., such as high-Z inert gases) and the high energy photons can lead to the liberation of electrons with various energy levels from the innermost electron shell(s) of the gas atoms 134.

The liberated electrons 300 can be distinguished by how they are liberated and can be identified as at least one of Auger electrons 320, Compton electrons 310, and field-coupled electrons 330.

Auger electrons 320 can be emitted from the near-surface region of emitter material where the vacancy is created by the Compton electron 210 emission and filled immediately by an electron neighboring in probability space. This vacancy filling electron motion disturbs the field potential balance which can overwhelm the band energy of a neighboring electron to be liberated. The Compton electrons 310 can be emitted from deeper within the atomic structure (e.g., such as from an inner electron shell) depending on the energy of the incident photons. The Compton electrons 310 can carry relatively high energy. The remaining of photon energy (e.g., after an initial atomic collision) can be high enough for the photon to undergo a subsequent interactions with another atom (e.g., secondary collision, tertiary collision, quaternary collision, quintenary collision, and so forth). Field-coupled electrons 330 can be liberated from the low energy quantum shell where electron(s) couples with the electromagnetic field disturbance of fast passing charges.

Compton electrons 310 can carry high energy and can impact an atom (e.g., an emitter material atom, a gas atom 134, a collector material atom, and the like) causing the liberation of additional electrons 300.

The gas pressure and the gap distance 136 can determine the photon coupling rate and transmission rate of liberated electrons 300 across the gap 130 (e.g., corresponding to the current density of the electric generator 100).

The selection of the gas pressure and gap distance 136 can be aided with the Paschen curve of a specific gas (e.g., high-Z inert gas).

### Commercial Potential:

Modified vacuum-gap of NTAC device to improve the performance.

Dielectric barrier discharge application.

Photoionization device.

Nuclear thermionic avalanche cell (NTAC) [1] uses the vacuum-gap that allows energetic electrons from emitter to run across by the difference of potential field strength between the emitter and collector, in addition to their kinetic energy. For this type of vacuum-gap, the energy and number of emitted electrons may increase the gap current. However, the energetic electrons from the emitter may include only a fraction of the liberated electrons. Remaining low-energy carrying liberated electrons may not have sufficient energy to cross over the vacuum-gap.

The present disclosure may provide new insight into the gap mechanism between the emitter and collector of NTAC. To further improve the electron emission from the emitter and electron capture by the collector electrons, topological micro- to nano-scale raggedness may be implemented on the emitter and collector surfaces. In addition, the gap may be modified by adding a high-Z gas which may provide a greater number of electrons which are able to be liberated and captured so as to increase the number of electrons in a stream of electrons that run across the gap.

The disclosed implementations can be implemented as an apparatus (a machine) that includes processing hardware configured, for example, by way of software executed by the processing hardware and/or by hardware logic circuitry, to perform the described features, functions, operations, processes, methods, steps, and/or benefits.

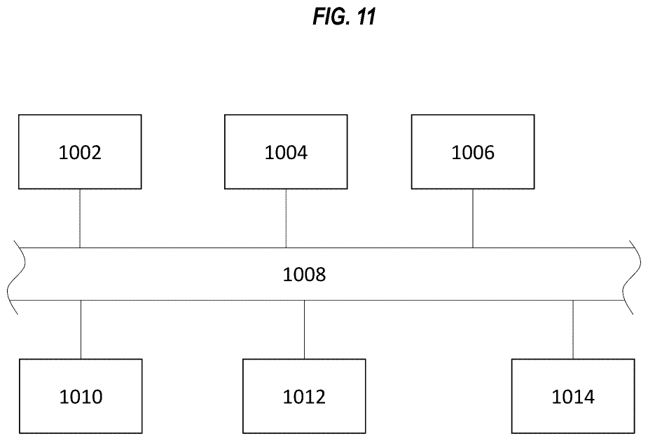

The disclosed implementation can include a computing apparatus, such as (in a non-limiting example) any computer or computer processor, that includes processing hardware and/or software implemented on the processing hardware to transmit and receive (communicate (network) with other computing apparatuses), store and retrieve from computer readable storage media, process and/or output data. According to an aspect of an implementation, the described features, functions, operations, processes, methods, steps, and/or benefits can be implemented by and/or use processing hardware and/or software executed by processing hardware. For example, a computing apparatus as illustrated in FIG. 11 can include a central processing unit (CPU) or a computing processing system 1004 (e.g., one or more processing devices (e.g., chipset(s), including memory, etc.) that can process or execute instructions, namely software, program(s), and/or application(s), which can be stored in a memory 1006 and/or a computer readable storage media 1012 (e.g., read-only memory (ROM), flash memory, hard disk, solid state memory, and the like), transmission communication interface (e.g., network interface, wire/wireless data network interface) 1010, input device 1014 (e.g., mouse, keyboard, multi-touch display, audio microphone, sensor, and the like), and/or an output device 1002, for example, a display device (e.g., multi-touch display, audio speaker, visual display, and the like), a printing device, and which are coupled (directly or indirectly) to each other, for example, can be in communication among each other through one or more data communication buses 1008.

In an implementation, the computing apparatus can be a controller configured to control of the electric generator 100. For example, the controller can be configured to control the flow of electrons from the collector 140 to produce an electric current. The controller can be configured to control the flow of gamma radiation 200 from the radionuclide 110 and the flow of electrons from the collector 140 to balance the rates of electrons liberated from the emitter 120 and from the gas atoms 134 to correspond to the rate of electrical current output from the collector 140.

In addition, an apparatus can include one or more apparatuses in computer network communication with each other or other apparatuses and the implementations relate to control and/or communication of aspects of the disclosed features, functions, operations, processes, methods, steps, and/or benefits, for example, data or information involving local area network (LAN) and/or Intranet based computing, cloud computing in case of Internet based computing, Internet of Things (IoT) (network of physical objects—computer readable storage media (e.g., databases, knowledge bases), devices (e.g., appliances, cameras, mobile phones), vehicles, buildings, and other items, embedded with electronics, software, sensors that generate, collect, search (query), process, and/or analyze data, with network connectivity to exchange the data), online websites. In addition, a computer processor can refer to one or more computer processors in one or more apparatuses or any combinations of one or more computer processors and/or apparatuses. An aspect of an implementation relates to causing and/or configuring one or more apparatuses and/or computer processors to execute the described operations. The results produced can be output to an output device, for example, displayed on the display or by way of audio/sound. An apparatus or device refers to a physical machine that performs operations by way of electronics, mechanical processes, for example, electromechanical devices, sensors, a computer (physical computing hardware or machinery) that implement or execute instructions, for example, execute instructions by way of software, which is code executed by computing hardware including a programmable chip (chipset, computer processor, electronic component), and/or implement instructions by way of computing hardware (e.g., in circuitry, electronic components in integrated circuits, etc.)—collectively referred to as hardware processor(s), to achieve the functions or operations being described. The functions of embodiments described can be implemented in a type of apparatus that can execute instructions or code.

More particularly, programming or configuring or causing an apparatus or device, for example, a computer, to execute the described functions of implementation of the disclosure creates a new machine where in case of a computer a general-purpose computer in effect becomes a special purpose computer once it is programmed or configured or caused to perform particular functions of the implementations of the disclosure pursuant to instructions from program software. According to an aspect of an embodiment, configuring an apparatus, device, computer processor, refers to such apparatus, device or computer processor programmed or controlled by software to execute the described functions.

A program/software implementing the embodiments may be recorded on a computer-readable storage media, e.g., a non-transitory or persistent computer-readable storage medium. Examples of the non-transitory computer-readable media include a magnetic recording apparatus, an optical disk, a magneto-optical disk, and/or volatile and/or non-volatile semiconductor memory (for example, random access memory (RAM), ROM, etc.). Examples of the magnetic recording apparatus include a hard disk device (HDD), a flexible disk (FD), and a magnetic tape (MT). Examples of the optical disk include a DVD (Digital Versatile Disc), DVD-Read-only memory (DVD-ROM), DVD-Random Access Memory (DVD-RAM), BD (Blue-ray Disk), a Compact Disc (CD)—Read Only Memory (CD-ROM), a CD-Recordable (CD-R) and/or CD-Rewritable (CD-RW). The program/software implementing the embodiments may be transmitted over a transmission communication path, e.g., a wire and/or a wireless network implemented via hardware. An example of communication media via which the program/software may be sent includes, for example, a carrier-wave signal.

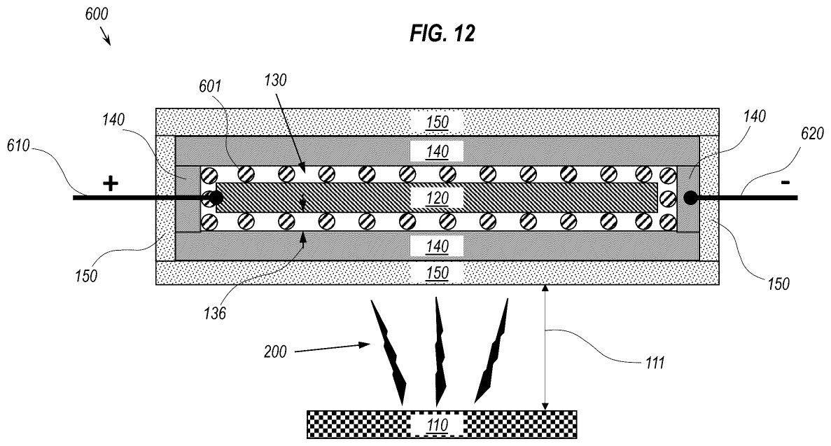

Referring to FIG. 12, the electric generator can include an encapsulated cell 600 having an emitter 120 surrounded by an emitter gap 130, and a collector 140. The emitter 120 and the collector 140 can also be surrounded by an optional insulator 150. The emitter gap 130 can be established and/or maintained by a gap set material 601 which can include a non-conductive material. For example, the gap set material 601 can include a layer of nylon, fiberglass, silicon, or the like which may be in the gap 130 so as to set the gap distance 136. The non-conductive layer may be a woven layer (e.g., having a loose weave that does not restrict electron flow between the emitter 120 and collector 140). The gap distance 136 can be the same on one or more sides of the emitter 120 or may be different.

A collector current conductor 400 can be configured to cross the optional insulator 150 (e.g., when included) and contact the collector 140 so as to be in electrical communication with the collector 140. The collector current conductor 400 (e.g., electrode) can be configured to conduct current with the collector 140 (e.g., conduct a flow of electrons from the collector 140). An emitter current conductor 402 (e.g., electrode) can be configured to cross the collector 140 and the optional insulator 150 (e.g., when included) and contact the emitter 120 so as to be in electrical communication with the emitter 120. The emitter current conductor 402 can be configured to conduct current with the emitter 120 (e.g., conduct a flow of electrons to the emitter 120).

A radionuclide 110 can be positioned away from the encapsulated cell 600 and configured transmit gamma radiation 200 towards the encapsulated cell 600. The radionuclide 110 can be positioned at a distance 111 from the encapsulated cell 600. For example, the distance 111 can be greater than or equal to about 1 mm, or greater than or equal to about 2 mm, or greater than or equal to about 3 mm, or greater than or equal to about 5 mm, or greater than or equal to about 10 mm, or greater than or equal to about 20 mm, or greater than or equal to about 25 mm, or greater than or equal to about 35 mm, or greater than or equal to about 50 mm, or greater than or equal to about 100 mm, or greater than or equal to about 200 mm, or greater than or equal to about 500 mm, or greater than or equal to about 1 meters (m). Further, the distance 111 can be less than or equal to about 10 m, or less than or equal to about 5 m, or less than or equal to about 3 m, or less than or equal to about 2 m, or less than or equal to about 1 m, or less than or equal to about 500 mm, or less than or equal to about 200 mm, or less than or equal to about 100 mm, or less than or equal to about 50 mm.[0123] In an implementation, the electric generator 100 can include a plurality of encapsulated cells 600 which are electrically connected in a series or parallel. The plurality of encapsulated cells 600 can receive gamma radiation 200 from the same radionuclide 110 source or from different radionuclide 110 sources. In an implementation, each encapsulated cell 600 of the plurality of encapsulated cells 600 can receive gamma radiation 200 from a separate radionuclide 110 positioned to transmit specifically (e.g., most directly) toward the encapsulated cell 600 of the plurality of encapsulated cells 600.

The encapsulated cell 600 can be configured in any suitable shape and arrangement. For example, the encapsulated cell 600 can have a planar, cylindrical, hemispherical, partially spherical, or like shape. The plurality of encapsulated cells 600 can stacked in a planar arrangement, or nested such as in a cylindrical, hemispherical, partially spherical, or like arrangement (e.g., where each encapsulated cell 600 of the plurality of encapsulated cells 600 can be concentric, such as concentric about a radionuclide 110 source).

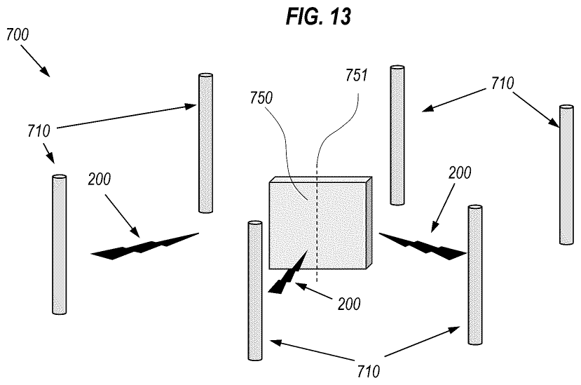

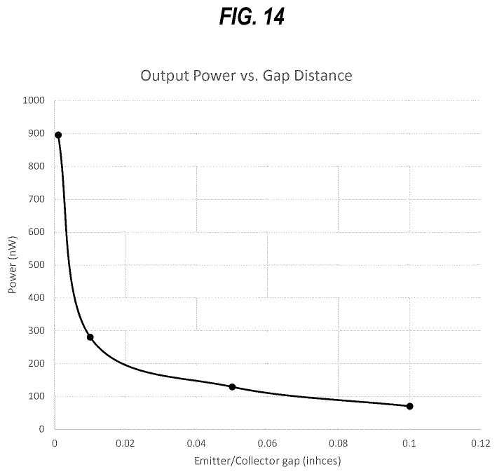

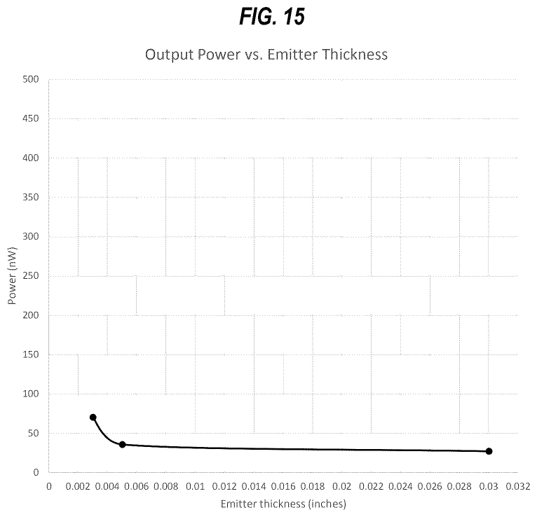

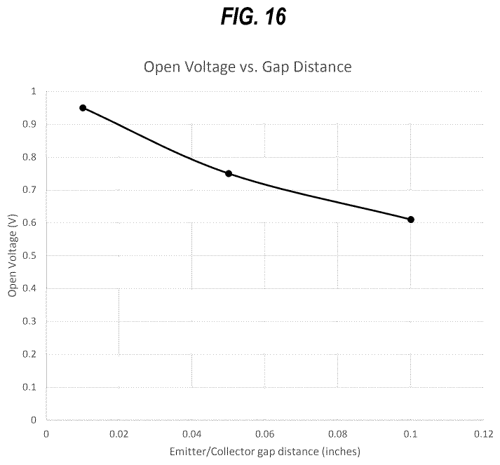

Referring to FIG. 13, in an experimental setup 700 a single layer target cell 750 (e.g., including a emitter 120 separated from a collector 140 by a gap 130 with gas atoms 134 in the gap 130) was placed so that a centerline 751 of the single layer target cell 750 was equidistant from six radionuclide 110 sticks as sources 710 of gamma radiation 200. During the experiment emitter thicknesses of the single layer target cell 750 from about 0.15 mm (0.006 inches) to about 2.5 mm (0.1 inches) were tested. Additionally, gap distance 136 from about 0.025 mm (0.001 inches) to about 5.1 mm (0.2 inches) were tested. The results of the testing are presented in FIGS. 14-16 which illustrate the power output as a function or gap distance (FIG. 14) and emitter thickness (FIG. 15), and open voltage as a function of gap distance (FIG. 16). The single layer target cell 750 used of FIG. 15 had a stainless steel emitter 120 and a 0.006 inch aluminum collector 140.

### REFERENCES

[1] U.S. Pat. No. 10,269,463, Apr. 23, 2019.
[2] https://www.researchgate.net/publication/228420807
[3] Wittenber, H. H., Gas Tube Design, RCA Electron Tube Division, pp. 792-817, 1962. https://g3ynh.info/disch_tube/Wittenberg_gas_tubes.pdf

The various implementations described herein serve as examples of aspects of the disclosure and should not be interpreted as to limit the scope of the present disclosure.

While various inventive implementations have been described and illustrated herein, those of ordinary skill in the art will readily envision a variety of other means and/or structures for performing the function(s) and/or obtaining the result(s) and/or one or more of the advantages described herein, and each of such variations and/or modifications is deemed to be within the scope of the implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, implementations may be practiced otherwise than as specifically described and claimed.

Implementations of the present disclosure are directed to each individual feature, system, article, material, and/or kit described herein. In addition, any combination of two or more such features, systems, articles, materials, and/or kits, if such features, systems, articles, materials, and/or kits, are not mutually inconsistent, is included within the inventive scope of the present disclosure. It is to be understood that a singular form of a noun corresponding to an item may include one or more of the items, unless the relevant context clearly indicates otherwise.

As used herein, each of the terms “weight %”, “wt %”, and “w/w” can refer the mass of the specified component divided by the total mass of the mixture in which the component is part.

As used herein, each of the terms “volume %” and “vol %” can refer the volume of the specified component divided by the total volume of the mixture in which the component is part.

As used herein, each of the term “v/w” can refer the volume of the specified component divided by the total mass of the mixture in which the component is part.

As used herein, each of the phrases “A or B,” “at least one of A and B,” “at least one of A or B,” “A, B or C,”, A, B, and C”, “at least one of A, B, and C,” and “at least one of A, B, or C” may include any one of the listed items, or all possible combinations thereof. For example, use of “at least one of” preceding a group of items should be interpreted in a disjunctive way with respect to the group of items, e.g., so that presence of one item of the group meets the meaning of the recitation.

The words “a,” “an” and “the” are intended to include plural forms of elements unless specifically referenced as a single element. The term “at least” preceding a listing of elements denotes any one or any combination of the elements in the listing. In other words, the expression “at least one of . . . ” when preceding a list of elements, modifies the entire list of elements and does not modify the individual elements of the list.

The term “and/or” includes a combination of a plurality of related listed components, or any component among the plurality of related listed components.

Terms such as “first,” “second,” or “first” or “second” may be used simply to distinguish one component from other components, and do not limit the components in other aspects (e.g., importance or order).

Further, terms such as “front”, “rear”, “top”, “bottom”, “side”, “left”, “right”, “upper”, and “lower” used in the present disclosure are defined based on the drawings, and the shape and location of each component are not limited by the terms.

The term “comprise(ing)”, “include(ing)” or “have(ing)” is intended to indicate the presence of a characteristic, number, step, operation, process, component, part, feature, function, and/or element, or any combination thereof described in the present document, and the possibility of the presence or addition of one or more other characteristics, numbers, steps, operations, processes, components, parts, features, functions, and/or elements, or any combination thereof is not precluded.

When a component is “connected,” “coupled,” “supported,” or “in contact” with another component, this includes not only cases in which components are directly connected, coupled, supported, or in contact with each other, but also cases in which they are indirectly connected, coupled, supported, or in contact through a third component.

When a component is disposed “on” another component, this includes not only a case in which the component is in contact with another component, but also a case in which still another member is present between the two components.

A term, such as “about” or “substantially,” is used at a corresponding numerical value or used as a meaning close to the numerical value when e.g., manufacturing and material tolerances which may be inherent in the stated meaning are presented. In particular, as used herein, the terms “about” and “approximately” refer to values that are plus or minus ten percent of the base value. That is, for example, reference to “about 100” or “approximately 100” refers to “90-110” inclusive. In some implementations, “about” may refer to plus or minus five percent of the base value, or plus or minus two percent of the base value.

What is claimed is:

1. An electric generator comprising:
a radionuclide configured to emit gamma radiation;
an emitter material having emitter material atoms to receive the emitted gamma radiation into the emitter material atoms so that, the gamma radiation causes one or more electrons of the emitter material atoms to be liberated from the emitter material atoms, and thereby be emitted from an emitter surface of the emitter material;
a collector material spaced apart from the emitter surface so as to form a gap between the emitter surface and a collector surface of the collector material; and
a gas having gas atoms and a gas pressure, in the gap, to receive, into the gas atoms, gamma radiation passed through the emitter material so that, the received gamma radiation causes one or more electrons of the gas atoms to be liberated from the gas atoms;
wherein electrons liberated from the emitter material atoms and electrons liberated from the gas atoms are received by the collector material, thereby causing an electrical potential difference between the emitter material and the collector material, and so that an electric current corresponding to a flow of liberated electrons between the emitter material and the collector material is producible from the collector material.

2. The electric generator of claim 1, wherein
the emitter material and the collector material each include a cylindrical shape so that the gap has an annular cross-sectional shape.

3. The electric generator of claim 1, wherein
the emitter material includes a plurality of spaced apart emitter material layers,
the collector material includes a plurality of spaced apart collector material layers respectively corresponding to the plurality of spaced apart emitter material layers so that a plurality of spaced apart gaps are formed between each emitter material of the plurality of spaced apart emitter material layers and each collector material of the plurality of spaced apart collector material layers, and
the plurality of spaced apart emitter material layers, the plurality of spaced apart collector material layers, and the plurality of spaced apart gaps are concentric.

4. The electric generator of claim 1, wherein the emitter material and the collector material each include a transition metal.

5. The electric generator of claim 1, wherein the gas is at least one of argon, krypton, xenon, and radon.

6. The electric generator of claim 1, wherein the electrical potential difference corresponds to a number of electrons emitted from the emitter material and a number of electrons received by the collector material.

7. The electric generator of claim 1, wherein the electric current corresponds to a number of electrons received by the collector material.

8. The electric generator of claim 1, wherein
the gap has a gap distance corresponding to a distance that the collector surface is spaced apart from the emitter surface, and
a product of the gas pressure and the gap distance is between about 0.2 mmHg-cm and about 50 mmHg-cm.

9. The electric generator of claim 8, wherein the gas includes argon, and the product is between about 0.5 mmHg-cm and about 3 mmHg-cm.

10. The electric generator of claim 8, wherein the gas includes krypton and the product is between about 1 mmHg-cm and about 15 mmHg-cm.

11. The electric generator of claim 8, wherein the gas includes xenon and the product is between about 1 mmHg-cm and about 8 mmHg-cm.

12. The electric generator of claim 8, wherein the gap distance is between about 1 millimeter and about 10 centimeters.

13. The electric generator of claim 1, further comprising an insulator configured to at least partially surround the gap.

14. The electric generator of claim 13, wherein the insulator extended between and coupled to edges of the emitter material and the collector material so that the gap is enclosed by the insulator.

15. The electric generator of claim 1, further comprising:
a containment chamber that includes a transition metal, and
the containment chamber is configured to surround the radionuclide, the emitter material, and the collector material, and to prevent gamma radiation from passing through the containment chamber.

16. The electric generator of claim 1, wherein
the emitter surface has a first surface texture which includes a plurality of first peaks having a mean first peak height and a plurality of first valleys having a mean first valley depth,
the collector surface has a second surface texture which includes a plurality of second peaks having a mean second peak height and a plurality of second valleys having a mean second valley depth, and
a first difference between the mean first peak height and the mean first valley depth is less than or equal to a second difference between the mean second peak height and the mean second valley depth.

17. The electric generator of claim 16, wherein the first difference is about two times to about 10 times the second difference.

18. The electric generator of claim 1, wherein the gas atoms receive electrons liberated from the emitter material so that, the received electrons cause one or more electrons contained in the gas atoms to be liberated from the gas atoms.

19. A method of configuring an electric generator including a radionuclide, an emitter material including emitter material atoms, and at least partially surrounding the radionuclide, a collector material at least partially surrounding the emitter material to form a gap between the emitter material and the collector material, and a gas including gas atoms in the gap, the electric generator configured to produce a flow of electrons, the method comprising:
connecting the emitter material to an emitter current conductor; and
connecting the collector material to a collector current conductor, to thereby form the electric generator that produces an electrical current based on transmission of gamma radiation from the radionuclide to the emitter material and gas thereby liberating electrons from the emitter material atoms and the gas atoms.

20. The method of claim 19, further comprising connecting at least one of the emitter current conductor and the collector current conductor to a controller configured to control a flow of electrons through the at least one of the emitter current conductor and the collector current conductor to produce an electric current.
